(19) United States
(12) Patent Application Publication
(10) Pub. No.: US 2026/0121233 A1
(43) Pub. Date: Apr. 30, 2026

(54) SEPARATOR FOR ELECTROCHEMICAL DEVICE, MANUFACTURING METHOD THEREOF AND ELECTROCHEMICAL DEVICE INCLUDING THE SAME

(71) Applicant: LG ENERGY SOLUTION, LTD., Seoul (KR)

(72) Inventors: Seung Hyun LEE, Daejeon (KR); Byeong Kyu Lee, Daejeon (KR); Yu Bae Kim, Daejeon (KR); Kyung Ryun KA, Daejeon (KR); Hye Won Kim, Daejeon (KR)

(21) Appl. No.: 19/373,520

(22) Filed: Oct. 29, 2025

(30) Foreign Application Priority Data
Oct. 30, 2024 (KR) 10-2024-0150855

(51) Int. Cl. H01M 50/491; H01M 50/403; H01M 50/417; H01M 50/443

(52) U.S. Cl. CPC H01M 50/491; H01M 50/403; H01M 50/417; H01M 50/443

(57) ABSTRACT

A separator for an electrochemical device includes a porous polymer substrate, and the Total Pore Volume San value of the porous polymer substrate is 0.65 or more.

### CROSS REFERENCES TO RELATED APPLICATIONS

This application is based on and claims priority from Korean Patent Application No. 10-2024-0150855, filed on Oct. 30, 2024, with the Korean Intellectual Property Office, the disclosure of which is incorporated herein in its entirety by reference.

### TECHNICAL FIELD

The present disclosure relates to a separator for an electrochemical device, a manufacturing method thereof, and an electrochemical device including the same.

### BACKGROUND

An electrochemical device converts chemical energy into electrical energy by using electrochemical reactions. In recent years, as one type of electrochemical devices, lithium secondary batteries, which have a high energy density, a high voltage, and a long cycle life and can be used in various fields, are widely used.

A lithium secondary battery may include an electrode assembly manufactured by combining a positive electrode, a negative electrode, and a separator disposed between the positive electrode and the negative electrode, and may be manufactured by accommodating the electrode assembly, together with an electrolyte solution, in a case.

### SUMMARY

The present disclosure provides a separator for an electrochemical device, in which the resistance may be lowered by controlling the Total Pore Volume Span value of the porous polymer substrate.

However, the present disclosure is not limited to the above-mentioned features, and other unmentioned features will be clearly understood by those skilled in the art from the following description.

In one embodiment of the present disclosure, provided is a separator for an electrochemical device, which includes a porous polymer substrate. In the separator for the electrochemical device, the Total Pore Volume Span value of the porous polymer substrate is about 0.65 or more.

According to one embodiment of the present disclosure, the porosity of the porous polymer substrate may be greater than about 45%.

According to one embodiment of the present disclosure, the electrical resistance (ER) of the porous polymer substrate may be about 0.37 ohm or less.

According to one embodiment of the present disclosure, the pore particle size D10 of the porous polymer substrate may be about 0.037 μm or less.

According to one embodiment of the present disclosure, the pore particle size D90 of the porous polymer substrate may be about 0.075 μm or more.

According to one embodiment of the present disclosure, the difference (D90-D10) in pore particle size of the porous polymer substrate may be about 40 nm or more.

According to one embodiment of the present disclosure, the pre-compression air permeability of the porous polymer substrate may be about 75 s/100 cc or less.

According to one embodiment of the present disclosure, the post-compression air permeability of the porous polymer substrate may be about 120 s/100 cc or less.

According to one embodiment of the present disclosure, the resistance increase rate of the separator for the electrochemical device may be about 40% or less.

In one embodiment of the present disclosure, provided is a manufacturing method of a separator for an electrochemical device, in which a polymer resin and a pore-forming agent are included, the method includes the step of stirring the polymer resin and the pore-forming agent to form a porous polymer substrate, and the pore-forming agent is added two or more times.

According to one embodiment of the present disclosure, the stirring speed of the polymer resin and the pore-forming agent during the first addition of the pore-forming agent may be larger than the stirring speed during the second addition of the pore-forming agent.

According to one embodiment of the present disclosure, the stirring speed of the polymer resin and the pore-forming agent during the first addition of the pore-forming agent may be about 1.5 to 3 times the stirring speed during the second addition of the pore-forming agent.

According to one embodiment of the present disclosure, the stirring speed of the polymer resin and the pore-forming agent may be about 100 RPM to 300 RPM during the first addition of the pore-forming agent, and may be about 50 RPM to 150 RPM during the second addition of the pore-forming agent.

According to one embodiment of the present disclosure, the stirring speed of the polymer resin and the pore-forming agent may be about 20 RPM to 80 RPM during the third addition of the pore-forming agent.

In one embodiment of the present disclosure, provided is an electrochemical device including: a positive electrode; a negative electrode; and one of the above-described separators, which is interposed between the positive electrode and the negative electrode.

In the separator for the electrochemical device according to one embodiment of the present disclosure, the air permeability and resistance are improved by controlling the Total Pore Volume Span value of the porous polymer substrate.

In the manufacturing method of the electrochemical device separator according to one embodiment of the present disclosure, the air permeability and resistance of the separator are improved by controlling the number of times the pore-forming agent is added and the stirring speed.

In the electrochemical device according to one embodiment of the present disclosure, the resistance is improved and the performance of the electrochemical device is improved by controlling the Total Pore Volume Span value of the porous polymer substrate included in the separator.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 illustrates a Total Pore Volume Span graph of a porous polymer substrate according to one embodiment of the present disclosure.

Corresponding reference characters indicate corresponding components throughout the several views of the drawings, but different reference characters may be given as necessary. The drawing FIGURES presented are illustrated for simplicity and clarity and have not necessarily been drawn to scale. For example, the dimensions of some of the elements in the FIGURES may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In this specification, when it is said that a certain part “includes” a certain component, this means that the certain part may further include other components rather than excluding other components unless specifically stated to the contrary.

In this specification, “A and/or B” means “A and B, or A or B.”

In this specification, “about,” “approximately,” and “substantially” are used to mean ranges of numerical values or degrees or approximations thereof, taking into account inherent manufacturing and material tolerances (e.g., +5%), and are used to prevent infringers from unfairly using the disclosed contents in which precise or absolute FIGURES provided for aiding the understanding of the present disclosure are mentioned.

In this specification, when one component is said to be provided “on” the other component, this does not exclude other components disposed between these, but means that other components may be further disposed unless specifically stated to the contrary.

In this specification, the characteristic of having pores means that the object includes a plurality of pores, and the pores are connected to each other to form a structure that allows gaseous and/or liquid fluid to pass from one side surface to the other side surface of the object.

In this specification, a separator has a porous characteristic including a large number of pores, and serves as a porous ion-conducting barrier that blocks an electrical contact between a negative electrode and a positive electrode in an electrochemical device while allowing ions to pass.

Among the components of an electrochemical device, a separator may include a polymer substrate having a porous structure located between a positive electrode and a negative electrode. The separator serves to prevent an electrical short between the positive electrode and the negative electrode by separating two electrodes from each other while serving to allow an electrolyte and ions to pass therethrough. Although the separator itself does not participate in an electrochemical reaction, physical properties such as wettability to an electrolyte solution, porosity, and thermal shrinkage may affect the performance and safety of the electrochemical device.

A polyolefin (e.g., polyethylene, polypropylene, and the like)-based film is used for a porous polymer substrate included in the separator. These separators may be manufactured through a wet manufacturing method or a dry manufacturing method. In the wet manufacturing method, pores are formed by using a pore-forming agent. In the dry manufacturing method, a polymer material is melted and prepared into the form of a film, and then is stretched, thereby forming pores.

In the present disclosure, the air permeability and resistance of the porous polymer substrate are improved by controlling the sizes and distribution of pores formed in the porous polymer substrate.

Hereinafter, the present disclosure will be described in more detail.

The electrochemical device according to one embodiment of the present disclosure includes a positive electrode and a negative electrode, and a separator interposed between the positive electrode and the negative electrode. The separator includes: a porous polymer substrate; and a coating layer that is provided on at least one surface of the porous polymer substrate and includes inorganic particles. The electrochemical device according to one embodiment of the present disclosure may further include an electrolyte solution (not illustrated), a case (not illustrated), and the like.

In the separator for the electrochemical device included in one embodiment of the present disclosure, the Total Pore Volume Span value of the porous polymer substrate is about 0.65 or more in the electrochemical device separator including the porous polymer substrate.

In the separator for the electrochemical device according to one embodiment of the present disclosure, the air permeability and resistance are improved by controlling the Total Pore Volume Span value of the porous polymer substrate.

The separator for the electrochemical device includes the porous polymer substrate. As described above, since the separator for the electrochemical device includes the porous polymer substrate, it is possible to allow lithium ions to pass while blocking electrical contact. Then, a shutdown function may be implemented at an appropriate temperature.

According to one embodiment of the present disclosure, the porous polymer substrate may be manufactured using a polyolefin-based resin as a base resin. Examples of the polyolefin-based resin may include polyethylene, polypropylene, and polypentene, and at least one type of these may be included. A porous separator manufactured using this polyolefin-based resin as a base resin, for example, a separator having a large number of pores, may provide a shutdown function at an appropriate temperature. The shutdown function is a function that prevents thermal runaway, in which when the battery is overheated, the separator blocks its pores, thereby cutting off the current flow. In this function, when the internal temperature of the battery rises above a certain temperature, the separator melts so that its pores are blocked, thereby blocking the contact between the positive electrode and the negative electrode and stopping the current flow.

According to one embodiment of the present disclosure, the weight average molecular weight of the polyolefin-based resin may be about 500,000 to 1,500,000. By adjusting the weight average molecular weight of the polyolefin-based resin within the above-described range, the compression resistance of the separator may be improved. Furthermore, when a mixture of different types of polyolefin-based resins is used or a separator is formed with a multi-layered structure made of different types of polyolefin-based resins, the weight average molecular weight of the polyolefin-based resin may be calculated by adding up the weight average molecular weights according to the respective content ratios of the polyolefin-based resins.

In this specification, the weight average molecular weight (Mw) may be measured by gel permeation chromatography (GPC, PL GPC220, Agilent Technologies, Inc.), and the measurement conditions may be set as follows.
Column: PL Olexis (Polymer Laboratories)
Solvent: TCB (Trichlorobenzene)
Flow rate: 1.0 ml/min
Sample Concentration: 1.0 mg/ml
Injection volume: 200 μl
Column Temperature: 160° C.
Detector: Agilent High Temperature RI detector
Standard: Polystyrene (corrected by a cubic function)

According to one embodiment of the present disclosure, the Total Pore Volume Span value of the porous polymer substrate is about 0.65 or more. For example, the Total Pore Volume Span value of the porous polymer substrate may be about 0.65 to 0.90, 0.66 to 0.89, 0.67 to 0.88, 0.68 to 0.87, 0.69 to 0.86, 0.70 to 0.85, 0.71 to 0.84, or 0.72 to 0.84. In the pore size distribution within the above-described range, the number of pores with relatively large sizes is increased, thereby improving the air permeability and resistance characteristics. Also, by controlling the Total Pore Volume Span value of the porous polymer substrate within the above-described range, the pore size distribution becomes wider. Thus, even after compression during a manufacturing process, pore sizes may be maintained above a certain level, thereby suppressing an increase in permeation time and an increase in resistance. Furthermore, in the case of the electrochemical device utilizing this, the Total Pore Volume Span value of the porous polymer substrate may be controlled so that even if the internal pressure increases during progress of cycles, a decrease in pore size may be suppressed, thereby minimizing an increase in resistance.

The Total Pore Volume Span refers to the sizes and distribution state of pores existing in a material (e.g., a separator), and is expressed as a curve or data indicating pore sizes and a relative ratio of pores having the corresponding sizes in one embodiment. The Total Pore Volume Span is directly related to the physical and chemical properties of the separator such as permeability, strength, adsorption, reactivity, and storage capacity of the separator.

According to one embodiment of the present disclosure, the Total Pore Volume Span value may be calculated by Equation 1:

$$Total Pore Volume Span = \frac{D 90 - D 10}{D 50} \qquad [ Equation l ]$$

Here, the D10, D50, and D90 mean average pore sizes corresponding to the bottom 10%, the median value, and the top 90% in the pore size distribution of the porous polymer substrate, and the Total Pore Volume Span is measured by an aqua pore measuring device.

According to one embodiment of the present disclosure, the “D10, D50, and D90” refer to average particle sizes at the points of 10%, 50%, and 90% in the cumulative distribution of the number of particles based on the particle size.

The particle size may be measured by using a laser diffraction method. Specifically, a measurement target is dispersed in a dispersion medium, and then is introduced into a commercially available laser diffraction particle size measurement device (e.g., Microtrac S3500). Then, when the particles pass through laser beam, the particle size distribution is calculated by measuring the difference in the diffraction pattern according to the particle size. The particle sizes D10, D50, and D90 may be measured by calculating the average particle diameters at the points of 10%, 50%, and 90%, respectively, in the cumulative distribution of the number of particles based on the particle size, in the measuring device. In addition, the Total Pore Volume Span may be measured through various methods such as mercury intrusion porosimetry (MIP) or a nitrogen adsorption method (BET, BJH). In the MIP, high-pressure mercury is injected to analyze the sizes and distribution of pores. In the nitrogen adsorption method, nano-sized pores are analyzed by adsorption and desorption of nitrogen.

According to one embodiment of the present disclosure, the porosity of the porous polymer substrate may be greater than 45%. For example, the porosity of the porous polymer substrate may be greater than about 45% and 70% or less, 46% to 68%, 46% to 66%, 46% to 64%, 46% to 62%, 46% to 60%, 46% to 58%, 46% to 56%, 46% to 55%, 46% to 54%, 46% to 53%, or 47% to 52%. In the above-described range of porosity, it is possible to prevent an increase in resistance of the separator and an increase in resistance of the electrochemical device, and to prevent or suppress the reduction of the mechanical strength of the separator.

According to one embodiment of the present disclosure, the porosity refers to the ratio of the volume occupied by pores to the volume of the separator, and the porosity may be measured in accordance with ASTM D-2873.

According to one embodiment of the present disclosure, the electrical resistance (ER) of the porous polymer substrate may be about 0.37 ohm or less. For example, the electrical resistance (ER) of the porous polymer substrate may be about 0.1 ohm to 0.37 ohm, 0.15 ohm to 0.37 ohm, 0.2 ohm to 0.37 ohm, 0.25 ohm to 0.37 ohm, 0.3 ohm to 0.37 ohm, or 0.35 ohm to 0.37 ohm. By controlling the electrical resistance (ER) value of the porous polymer substrate within the above-described range, it is possible to improve the performance of the separator. For example, the electrical resistance (ER) of the porous polymer substrate may be controlled by the Total Pore Volume Span value of the porous polymer substrate. As the Total Pore Volume Span value of the porous polymer substrate increases, the pore size distribution of the porous polymer substrate becomes wider and includes pores with sizes equal to or greater than a certain size. Thus, even if pore sizes are changed due to the compression and the progress of cycles, an increase in resistance may be minimized.

According to one embodiment of the present disclosure, in the measurement of the electrical resistance (ER), each separator according to one embodiment of the present disclosure is interposed between SUS plates to manufacture each coin cell. Then, an electrolyte solution is injected to the coin cell. The electrolyte solution contains 1 M of LiPF₆ in a mixture of ethylene carbonate:ethylmethyl carbonate in a volume ratio of 1:2. In measuring the resistance of the coin cells, the electrical resistance may be measured through electrochemical impedance spectroscopy analysis results by using VMP3 of BioLogic Science Instrument, under conditions including an amplitude of 10 mV and a scan range of 0.1 Hz to 1 MHz at 25° C.

According to one embodiment of the present disclosure, the pore particle size D10 of the porous polymer substrate may be about 0.037 μm or less. For example, the pore particle size D10 of the porous polymer substrate may be about 0.01 μm to 0.037 μm, 0.015 μm to 0.037 μm, 0.02 μm to 0.037 μm, 0.025 μm to 0.037 μm, 0.027 μm to 0.037 μm, or 0.03 μm to 0.036 μm. Within the above-described range of the pore particle size D10, the Total Pore Volume Span value of the porous polymer substrate may not be decreased while the increase in permeation time and resistance may be minimized. In this manner, by controlling the pore particle size D10 of the porous polymer substrate within the above-described range, the Total Pore Volume Span value of the porous polymer substrate may be increased, thereby minimizing the increase in permeation time and resistance.

According to one embodiment of the present disclosure, the pore particle size D90 of the porous polymer substrate may be about 0.075 μm or more. For example, the pore particle size D90 of the porous polymer substrate may be about 0.075 μm to 0.1 μm, 0.075 μm to 0.095 μm, 0.075 μm to 0.09 μm, 0.075 μm to 0.085 μm, 0.076 μm to 0.084 μm, 0.077 μm to 0.083 μm, 0.078 μm to 0.082 μm, 0.078 μm to 0.081 μm, or 0.078μ m to 0.08 μm. Within the above-described range of the pore particle size D90, the Total Pore Volume Span value of the porous polymer substrate may not be greatly decreased while the increase in permeation time and resistance may be minimized. In this manner, by controlling the pore particle size D90 of the porous polymer substrate within the above-described range, the Total Pore Volume Span value of the porous polymer substrate may be increased, thereby minimizing the increase in permeation time and resistance.

According to one embodiment of the present disclosure, the difference (D90-D10) in pore particle size of the porous polymer substrate may be about 40 nm or more. For example, the difference (D90-D10) in pore particle size of the porous polymer substrate may be about 40 nm to 100 nm, 40 nm to 90 nm, 40 nm to 80 nm, 40 nm to 70 nm, 40 nm to 60 nm, or 40 nm to 50 nm. By controlling the difference (D90-D10) in pore particle size of the porous polymer substrate within the above-described range, the Total Pore Volume Span value of the porous polymer substrate may be increased, thereby minimizing the increase in permeation time and resistance.

According to one embodiment of the present disclosure, the pre-compression air permeability of the porous polymer substrate may be about 75 s/100 cc or less. For example, the pre-compression air permeability of the porous polymer substrate may be about 50 s/100 cc to 75 s/100 cc, 52 s/100 cc to 75 s/100 cc, 54 s/100 cc to 75 s/100 cc, 55 s/100 cc to 75 s/100 cc, 56 s/100 cc to 75 s/100 cc, or 57 s/100 cc to 75 s/100 cc. Within the above-described range of the pre-compression air permeability, an increase in resistance of the separator may be minimized.

According to one embodiment of the present disclosure, the post-compression air permeability of the porous polymer substrate may be about 120 s/100 cc or less. For example, the post-compression air permeability of the porous polymer substrate may be about 80 s/100 cc to 120 s/100 cc, 85 s/100 cc to 120 s/100 cc, 90 s/100 cc to 120 s/100 cc, 95 s/100 cc to 120 s/100 cc, 97 s/100 cc to 120 s/100 cc, 97 s/100 cc to 115 s/100 cc, or 97 s/100 cc to 110 s/100 cc. Within the above-described range of the post-compression air permeability, an increase in resistance of the separator may be minimized.

According to one embodiment of the present disclosure, the air permeability is the air permeability (air permeation time, Gurley) of the porous polymer substrate according to one embodiment of the present disclosure and may be measured by a method of ASTM D726-94. The Gurley is a resistance to air flow, and may be measured by a Gurley densometer. The air permeability value described herein may be expressed as the time (sec) it takes for 100 cc of air to pass through a cross-section of 1 in² of a separator under a pressure of 12.2 in H₂O, for example, the air permeation time. The air permeability may be measured as each of pre-compression air permeability and post-compression air permeability.

According to one embodiment of the present disclosure, the thickness of the porous polymer substrate may be about 5 μm to 20 μm. For example, the thickness of the porous polymer substrate may be about 6 μm to 18 μm, 6 μm to 17 μm, 6 μm to 16 μm, 6μ m to 15 μm, 6μ m to 14 μm, 6μ m to 13 μm, 7 μm to 12 μm, 8 μm to 11 μm, or 9 μm to 11 μm. Within the above-described range of the thickness, it is possible to prevent or suppress the deterioration of the function of the separator and to suppress an increase in resistance and an increase in permeation time. In this manner, by controlling the thickness of the porous polymer substrate within the above-described range, the energy density of the battery may be improved.

According to one embodiment of the present disclosure, the thickness of the porous polymer substrate may be measured by using a thickness measuring device (Mitutoyo Corporation, VL-50S-B) through a contact-type measurement method.

According to one embodiment of the present disclosure, the resistance increase rate of the separator for the electrochemical device may be about 40% or less. For example, the resistance increase rate of the separator for the electrochemical device may be about 1% to 40%, 5% to 40%, 10% to 40%, 15% to 35%, 15% to 30%, 15% to 25%, or 17% to 24%. By controlling the resistance increase rate of the electrochemical device separator within the above-described range, the performance of the separator may be improved. For example, the resistance increase rate of the separator for the electrochemical device may be controlled by the Total Pore Volume Span value of the porous polymer substrate. As the Total Pore Volume Span value of the porous polymer substrate increases, the pore size distribution of the porous polymer substrate becomes wider and includes pores with sizes equal to or greater than a certain size. Thus, even when the pore sizes are changed due to the compression and the progress of cycles, an increase in resistance may be minimized.

According to one embodiment of the present disclosure, in relation to the resistance increase rate of the separator for the electrochemical device, the electrochemical device according to one embodiment of the present disclosure may be charged/discharged once at 0.1 C in a 25° C. chamber in a voltage range of 3.0 V to 4.35 V. Then, 1 C charging and 1 C discharging may be repeated for 300 cycles and a resistance may be measured before and after 300 cycles to calculate the resistance increase rate (%).

In one embodiment of the present disclosure, a polymer resin and a pore-forming agent are included, and a manufacturing method of a separator for an electrochemical device includes the step of: stirring the polymer resin and the pore-forming agent to form a porous polymer substrate. Then, it is characterized in that the pore-forming agent is added two or more times.

In the manufacturing method of the electrochemical device separator according to one embodiment of the present disclosure, it is possible to improve the air permeability and resistance of the separator by controlling the number of times the pore-forming agent is added and the stirring speed.

According to one embodiment of the present disclosure, the polymer resin may be prepared using a polyolefin-based resin as a base resin. Examples of the polyolefin-based resin may include polyethylene, polypropylene, and polypentene, and at least one type of these may be included. A porous separator manufactured using this polyolefin-based resin as a base resin, for example, a separator having a large number of pores, may provide a shutdown function at an appropriate temperature. According to one embodiment, the polymer resin may be a polyethylene resin.

According to one embodiment of the present disclosure, the pore-forming agent may be a substance that is dispersed within the polymer resin, exhibits heterogeneity in a substrate manufactured through extrusion, stretching, and the like, and is subsequently removed from this substrate. Therefore, the portions of the polymer of the substrate where the pore-forming agent is located may remain in the form of pores. The pore-forming agent is, for example, a liquid substance for an extrusion process, but a substance that is maintained in a solid state may also be used.

According to one embodiment of the present disclosure, the pore-forming agent may be an aliphatic hydrocarbon solvent such as solution-type paraffin, paraffin oil, mineral oil or paraffin wax; a vegetable oil such as soybean oil, sunflower oil, rapeseed oil, palm oil, coconut oil, corn oil, grapeseed oil, or cottonseed oil; or a plasticizer such as dialkyl phthalate. In particular, the plasticizer may be di-2-ethylhexyl phthalate (DOP), di-butyl-phthalate (DBP), di-isononyl phthalate (DINP), di-isodecyl phthalate (DIDP), or butyl benzyl phthalate (BBP). For example, the pore-forming agent may be solution-type paraffin. By selecting the pore-forming agent within the above-described range, the Total Pore Volume Span value of the porous polymer substrate may be controlled.

According to one embodiment of the present disclosure, the content ratio of the polymer resin to the pore-forming agent may be about 1:2 to 1:9, or may be 3:7 in one embodiment.

According to one embodiment of the present disclosure, the step of forming the porous polymer substrate by stirring the polymer resin and the pore-forming agent is included. As described above, by including the step of stirring the polymer resin and the pore-forming agent, it is possible to form the porous polymer substrate in which pores are formed.

According to one embodiment of the present disclosure, it is characterized in that the pore-forming agent may be added two or more times. As described above, due to a characteristic that the pore-forming agent is added two or more times, the pore size distribution may be suppressed from narrowing during pore formation regardless of the stirring speed. Then, it is possible to prevent or suppress a decrease in Total Pore Volume Span value of the porous polymer substrate and an increase in resistance and permeation time of the separator.

According to one embodiment of the present disclosure, it is characterized in that the pore-forming agent may be added three or more times. As described above, due to a characteristic that the pore-forming agent is added three or more times, the pore size distribution may be suppressed from narrowing during pore formation regardless of the stirring speed. Then, it is possible to prevent or suppress a decrease in Total Pore Volume Span value of the porous polymer substrate and an increase in resistance and permeation time of the separator.

According to one embodiment of the present disclosure, the stirring speed of the polymer resin and the pore-forming agent during the first addition of the pore-forming agent may be larger than the stirring speed during the second addition of the pore-forming agent. As described above, the stirring speed of the polymer resin and the pore-forming agent may be controlled such that the stirring speed for the first addition of the pore-forming agent is larger than the stirring speed for the second addition of the pore-forming agent, and thus the Total Pore Volume Span value of the porous polymer substrate may be increased.

According to one embodiment of the present disclosure, the stirring speed of the polymer resin and the pore-forming agent during the first addition of the pore-forming agent may be about 1.5 times to 3 times the stirring speed during the second addition of the pore-forming agent. For example, the stirring speed during the first addition of the pore-forming agent may be twice the stirring speed during the second addition of the pore-forming agent. By controlling the stirring speed for the first addition of the pore-forming agent and the stirring speed for the second addition of the pore-forming agent within the above-described ranges, it is possible to increase the Total Pore Volume Span value of the porous polymer substrate.

According to one embodiment of the present disclosure, the stirring speed of the polymer resin and the pore-forming agent may be about 100 RPM to 300 RPM during the first addition of the pore-forming agent, and may be about 50 RPM to 150 RPM during the second addition of the pore-forming agent. For example, the stirring speed may be about 150 RPM to 250 RPM during the first addition of the pore-forming agent, and may be about 75 RPM to 125 RPM during the second addition of the pore-forming agent. Alternatively, the stirring speed may be about 180 RPM to 220 RPM during the first addition of the pore-forming agent, and may be about 90 RPM to 110 RPM during the second addition of the pore-forming agent. By controlling the stirring speeds for the first addition and second addition of the pore-forming agent within the above-described ranges, it is possible to increase the Total Pore Volume Span value of the porous polymer substrate.

According to one embodiment of the present disclosure, the stirring speed of the polymer resin and the pore-forming agent may be about 20 RPM to 80 RPM during the third addition of the pore-forming agent. For example, the stirring speed may be about 40 RPM to 60 RPM during the third addition of the pore-forming agent. As described above, by controlling the stirring speed for the third addition of the pore-forming agent, it is possible to increase the Total Pore Volume Span value of the porous polymer substrate.

An electrochemical device included in one embodiment of the present disclosure includes: a positive electrode; a negative electrode; and one of the above-described separators, which is interposed between the positive electrode and the negative electrode.

In the electrochemical device according to one embodiment of the present disclosure, the Total Pore Volume Span value of the porous polymer substrate included in the separator may be controlled to improve the resistance and improve the performance of the electrochemical device.

According to one embodiment of the present disclosure, the positive electrode includes: a positive electrode current collector; and a positive electrode active material layer including a positive electrode active material, a conductive material, and a binder resin, on at least one surface of the current collector. The positive electrode active material may include one type or a mixture of two or more types among layered compounds such as lithium manganese composite oxide (e.g., LiMn₂O₄ and LiMnO₂), lithium cobalt oxide (LiCoO₂), and lithium nickel oxide (LiNiO₂) or compounds substituted with one or more transition metals; lithium manganese oxide such as chemical formulas Li₁₊ₓMn₂₋ₓO₄ (where x is 0 to 0.33), LiMnO₃, LiMn₂O₃, and LiMnO₂; lithium copper oxide (Li₂CuO₂); vanadium oxide such as LiV₃O₈, LiV₃O₄, V₂O₅, and Cu₂V₂O₇; Ni site-type lithium nickel oxide represented by a chemical formula LiNi₁₋ₓMₓO₂ (where M=Co, Mn, Al, Cu, Fe, Mg, B or Ga, and x=0.01 to 0.3); lithium manganese composite oxide represented by a chemical formula LiMn₁₋ₓMₓO₂ (where M=Co, Ni, Fe, Cr, Zn or Ta, and x=0.01 to 0.1) or Li₂Mn₃MO₈ (where M=Fe, Co, Ni, Cu or Zn); LiMn₂O₄ in which a part of Li in the chemical formula is substituted with an alkaline earth metal ion; a disulfide compound; and Fe₂(MoO₄)₃.

According to one embodiment of the present disclosure, the negative electrode includes: a negative electrode current collector; and a negative electrode active material layer including a negative electrode active material, a conductive material, and a binder resin, on at least one surface of the current collector. The negative electrode may include, as for the negative electrode active material, one type or a mixture of two or more types selected from lithium metal oxides; carbon such as non-graphitizable carbon, or graphite-based carbon; metal composite oxides such as LixFe₂O₃ (0≤x≤1), LiₓWO₂ (0≤x≤1), and SnₓMe₁₋ₓMe′_{y}O_{z} (Me: Mn, Fe, Pb, or Ge; Me′: Al, B, P, Si, elements of groups 1, 2, and 3 of the periodic table, or halogen; 0<x≤1; 1≤y≤3; 1≤z≤8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxide.

According to one embodiment of the present disclosure, the conductive material may be any one selected from, for example, graphite, carbon black, carbon fiber or metal fiber, metal powder, conductive whiskers, conductive metal oxide, activated carbon, and polyphenylene derivatives, or a mixture of two or more types of conductive materials among these. Alternatively, the conductive material may be one type selected from natural graphite, artificial graphite, super-p, acetylene black, Ketjen black, channel black, furnace black, lamp black, thermal black, Denka black, aluminum powder, nickel powder, zinc oxide, potassium titanate, and titanium oxide, or a mixture of two or more types of conductive materials among these.

According to one embodiment of the present disclosure, the current collector is not particularly limited as long as it has high conductivity without causing chemical changes in the corresponding battery. For example, stainless steel, copper, aluminum, nickel, titanium, calcined carbon, or aluminum or stainless steel whose surface is treated with carbon, nickel, titanium, silver, and the like, may be used.

According to one embodiment of the present disclosure, as for the binder resin, a polymer commonly used for electrodes in the art may be used. Non-limiting examples of this binder resin may include polyvinylidene fluoride-co-hexafluoropropylene, polyvinylidene fluoride-co-trichloroethylene, polymethyl methacrylate, polyethylhexyl acrylate, polybutyl acrylate, polyacrylonitrile, polyvinylpyrrolidone, polyvinyl acetate, polyethylene-co-vinyl acetate, polyethylene oxide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, and carboxyl methyl cellulose, and are not limited thereto.

According to one embodiment of the present disclosure, a positive electrode slurry for preparing the positive electrode active material layer may contain a dispersant. The dispersant may be a pyrrolidone-based compound, and specifically, may be N-methylpyrrolidone (ADC-01, LG Chemical).

According to one embodiment of the present disclosure, the electrochemical device may further include an electrolyte solution E containing an electrolyte, and the electrolyte includes a salt having a structure such as A⁺B⁻, which may be dissolved or dissociated in an organic solvent, but the present disclosure is not limited thereto. A⁺ may include alkali metal cations such as Li⁺, Na⁺, and K⁺ or ions composed of combinations thereof. Also, B may include anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻ or ions composed of combinations thereof. The organic solvent includes propylene carbonate (PC), ethylene carbonate (EC), diethylcarbonate (DEC), dimethylcarbonate (DMC), dipropylcarbonate (DPC), dimethylsulfoxide, acetonitrile, dimethoxyethane, diethoxyethane, tetrahydrofuran, N-methyl-2-pyrrolidone (NMP), ethyl methyl carbonate (EMC), gamma butyrolactone or a mixture thereof.

According to one embodiment of the present disclosure, the electrochemical device may be a cylindrical electrochemical device including the separator, the positive electrode, and the negative electrode according to the above description. Here, the above-described separator may be interposed between the positive electrode and the negative electrode in the order of ‘separator-negative electrode-separator-positive electrode’. These may be stacked in the form of an electrode assembly and may be wound into a jelly roll shape to manufacture a cylindrical electrochemical device. Meanwhile, in addition, the electrochemical device of the present disclosure may be a pouch-shaped or prismatic electrochemical device depending on the shape of the case accommodating the electrode assembly.

Hereinafter, the present disclosure will be further described in detail with reference to Examples. However, Examples according to the present disclosure may be modified in various different forms, and the scope of the present disclosure is not construed as being limited to Examples described below. Examples of the present specification are provided to more completely illustrate the present disclosure, to those having average knowledge in the art.

### Comparative Example 1

A polyethylene resin (PE, weight average molecular weight 1,000,000, Tm: 135° C.) was prepared as a polymer resin and solution-type paraffin was prepared as a pore-forming agent. The content ratio of the polyethylene and the solution-type paraffin was 3:7.

The solution-type paraffin was added to the polyethylene solution once and then was stirred at a speed of 200 RPM.

Then, the mixture was extruded using an extruder to obtain an extrudate, and the extrudate was passed through a cooling roll to manufacture an extruded sheet. The extruded sheet was stretched by using a biaxial stretching machine at 100° C. to a MD-direction stretching ratio of 400%. Next, the sheet was stretched at a temperature of 130° C. in the TD direction to a ratio of 400% of its initial introduction width.

The solution-type paraffin was removed from the stretched sheet by using a solvent methyl chloride (MC), and then heat-treatment was performed at a temperature of 120° C. for 1 min to 2 min to manufacture a porous polymer substrate (thickness: 10 μm, porosity: 45%, air permeability before compression: 90 s/100 cc, ER: 0.38 ohm).

Here, the Total Pore Volume Span value of the porous polymer substrate is 0.55.

### Comparative Example 2

A porous polymer substrate was manufactured (thickness: 10 μm, porosity: 45%, air permeability before compression: 80 s/100 cc, ER: 0.38 ohm) through the same process as in Comparative Example 1 except that in Comparative Example 1, the stirring was performed at a speed of 100 RPM after the solution-type paraffin was added once.

Here, the Total Pore Volume Span value of the porous polymer substrate is 0.63.

### Example 1

A porous polymer substrate was manufactured (thickness: 10 μm, porosity: 47%, air permeability before compression: 75 s/100 cc, ER: 0.37 ohm) through the same process as in Comparative Example 1 except that in Comparative Example 1, after the first addition of the solution-type paraffin, stirring was performed at a speed of 200 RPM, and after the second addition of the solution-type paraffin, stirring was performed at a speed of 100 RPM.

Here, the Total Pore Volume Span value of the porous polymer substrate is 0.72.

### Example 2

A porous polymer substrate was manufactured (thickness: 10 μm, porosity: 52%, air permeability before compression: 57 s/100 cc, ER: 0.35 ohm) through the same process as in Comparative Example 1 except that in Comparative Example 1, after the first addition of the solution-type paraffin, stirring was performed at a speed of 200 RPM, after the second addition of the solution-type paraffin, stirring was performed at a speed of 100 RPM, and then after the third addition of the solution-type paraffin, stirring was performed at a speed of 50 RPM.

Here, the Total Pore Volume Span value of the porous polymer substrate is 0.84.

### <Manufacturing of Electrochemical Device>

An electrochemical device was manufactured by using an electrochemical device separator including a porous polymer substrate in each of Examples and Comparative Examples.

### 1) Manufacturing of Positive Electrode

A positive electrode active material (LiNi_{0.8}Mn_{0.1}Co_{0.1}O₂), a conductive material (carbon black), a dispersant (N-methylpyrrolidone, ADC-01, LG Chemical), and a binder resin (a mixture of PVDF-HFP and PVDF) were mixed with water at a weight ratio of 97.5:0.7:0.14:1.66 to prepare a slurry for a positive electrode active material layer in which the concentration of the remaining components excluding water was 50 wt %. Next, the slurry was applied to the surface of an aluminum thin film (thickness of 10 μm) and was dried to manufacture a positive electrode having a positive electrode active material layer (thickness of 120 μm).

### 2) Manufacturing of Negative Electrode

Graphite (a blend of natural graphite and artificial graphite), a conductive material (carbon black), a dispersant (polyvinylpyrrolidone, Junsei, Japan), and a binder resin (a mixture of PVDF-HFP and PVDF) were mixed with water at a weight ratio of 97.5:0.7:0.14:1.66 to prepare a slurry for a negative electrode active material layer in which the concentration of the remaining components excluding water was 50 wt %. Next, the slurry was applied to the surface of a copper thin film (thickness of 10 μm) and was dried to manufacture a negative electrode having a negative electrode active material layer (thickness of 120 μm).

### 3) Manufacturing of Cylindrical Electrochemical Device

The separator of Examples and Comparative Examples was interposed between the manufactured negative electrode and positive electrode, and these were stacked in the order of separator-negative electrode-separator-positive electrode.

The electrode assembly stack was bound to a roll core, rolled, and then was wound into a jelly roll shape. Then, this electrode assembly was inserted into a cylindrical can to manufacture a cylindrical electrochemical device.

### Experimental Example

### Calculation of Total Pore Volume Span Value

The Total Pore Volume Span value may be calculated as follows.

$$Total Pore Volume Span = \frac{D 90 - D 10}{D 50}$$

Here, D10, D50, and D90 mean pore sizes corresponding to the bottom 10%, the median value, and the top 90% in the pore size distribution of the porous polymer substrate, and are measured by an aqua pore measuring device.

### Measurement of Electrical Resistance (ER)

The separator of each of Examples and Comparative Examples was interposed between SUS plates to manufacture each coin cell. An electrolyte solution was injected to the coin cell. The electrolyte solution contained 1 M of LiPF₆ in a mixture of ethylene carbonate:ethylmethyl carbonate in a volume ratio of 1:2. In measuring the resistance of the coin cells, the resistance was measured through electrochemical impedance spectroscopy analysis results by using VMP3 of BioLogic Science Instrument, under conditions including an amplitude of 10 mV and a scan range of 0.1 Hz to 1 MHz at 25° C., and is noted in Table 1 below.

### Measurement of Air Permeability

The air permeability (air permeation time, Gurley) of the porous polymer substrate of Examples and Comparative Examples was measured by a method of ASTM D726-94. The Gurley used herein is a resistance to air flow, and is measured by a Gurley densometer. The air permeability value described herein is expressed as the time (sec) it takes for 100 cc of air to pass through a cross-section of 1 in² of a separator under a pressure of 12.2 in H₂O, i.e., the air permeation time. The air permeability was measured as each of pre-compression air permeability and post-compression air permeability, and is noted in Table 1 below.

### Measurement of Resistance Increase Rate

The cylindrical electrochemical device of Examples and Comparative Examples was charged/discharged once at 0.1 C in a 25° C. chamber in a voltage range of 3.0 V to 4.35 V. Then, 1 C charging and 1 C discharging was repeated for 300 cycles, and a resistance was measured before and after 300 cycles. The resistance increase rate (%) was determined and is noted in Table 1 below.

TABLE 1

| | | Comparative | Comparative | | |
|---|---|---|---|---|---|
| | | Example 1 | Example 2 | Example 1 | Example 2 |
| Number of times (times) pore-forming | | 1 | 1 | 2 | 3 |
| agent is added | | | | | |
| Stirring speed (RPM/addition) | | 200 | 100 | 200/100 | 200/100/50 |
| Porous polymer | Porosity (%) | 45 | 45 | 47 | 52 |
| substrate | ER (ohm) | 0.38 | 0.38 | 0.37 | 0.35 |
| Total pore volume span value | | 0.55 | 0.63 | 0.72 | 0.84 |
| Pore size (μm) | D10 | 0.03755 | 0.03855 | 0.036 | 0.03 |
| | D50 | 0.05392 | 0.05592 | 0.057 | 0.059 |
| | D90 | 0.067 | 0.07449 | 0.078 | 0.08 |
| Air permeability | Before compression | 90 | 80 | 75 | 57 |
| (s/100 cc) | After compression | 150 | 130 | 110 | 97 |

| | | | | |
|---|---|---|---|---|
| Resistance increase rate (%) | 50 | 43 | 24 | 17 |

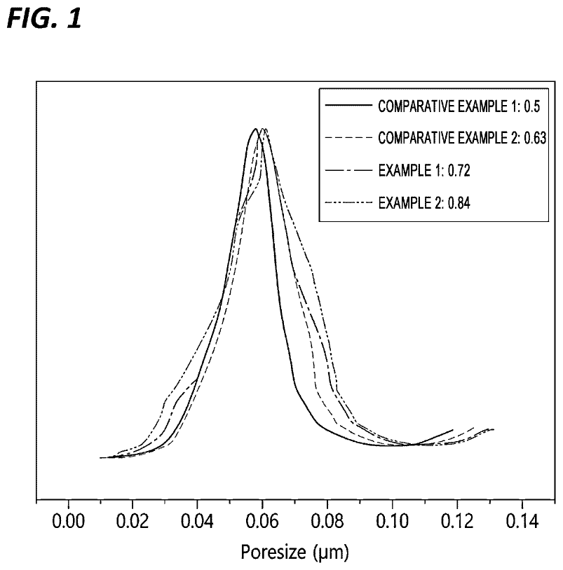

FIG. 1 illustrates a Total Pore Volume Span graph of a porous polymer substrate according to one embodiment of the present disclosure.

Referring to Table 1, it can be seen that the Total Pore Volume Span values of the porous polymer substrates in Examples 1 and 2 are 0.72 and 0.84, respectively, which are 0.65 or more. Meanwhile, in the case of Comparative Examples 1 and 2, the Total Pore Volume Span values of the porous polymer substrates are 0.55 and 0.63, respectively, which are 0.65 or less. Also, referring to FIG. 1, it can be seen that the pore size distributions of Examples 1 and 2 are more widely spread than the distributions of Comparative Examples 1 and 2.

Meanwhile, in the case of Examples 1 and 2, the post-compression air permeabilities of the porous polymer substrates are 110 s/100 cc and 97 s/100 cc, respectively, which are 120 s/100 cc or less. In the case of Comparative Examples 1 and 2, it was found that the post-compression air permeabilities are 150 s/100 cc and 130 s/100 cc, respectively, which are greater than 120 s/100 cc.

Also, the resistance increase rates of Examples 1 and 2 are 24% and 17%, respectively, and it can be found that the resistance increase rates decreased compared to the resistance increase rates 50% and 43% in Comparative Examples 1 and 2. For example, according to FIG. 1 and Table 1, and the above analysis results in relation to Examples 1 and 2 in which the Total Pore Volume Span value of the porous polymer substrate was adjusted to 0.65 or more, it can be found that in the case of Comparative Examples 1 and 2 in which the Total Pore Volume Span value of the porous polymer substrate was less than 0.65, the post-compression air permeability of the substrate is 120 s/100 cc or more and is relatively higher than those in Examples 1 and 2, and the resistance of the electrochemical device manufactured using this relatively significantly increases compared to those in the case of Examples 1 and 2.

Therefore, on the basis of these results, it can be seen that in the electrochemical device separator according to one embodiment of the present disclosure, by controlling the Total Pore Volume Span value of the porous polymer substrate, the air permeability of the separator and the resistance characteristics of the electrochemical device were improved.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below. Therefore, the technical scope of the various embodiments of the present disclosure is not limited to that in the Detailed Description section above, and may be defined by the claims.

What is claimed is:

1. A separator for an electrochemical device, the separator comprising:
a porous polymer substrate,
wherein a Total Pore Volume Span value of the porous polymer substrate is 0.65 or more.

2. The separator according to claim 1, wherein the porosity of the porous polymer substrate is greater than 45%.

3. The separator according to claim 1, wherein the electrical resistance (ER) of the porous polymer substrate is 0.37 ohm or less.

4. The separator according to claim 1, wherein the pore particle size D10 of the porous polymer substrate is 0.037 μm or less.

5. The separator according to claim 1, wherein the pore particle size D90 of the porous polymer substrate is 0.075 μm or more.

6. The separator according to claim 1, wherein the difference (D90-D10) in pore particle size of the porous polymer substrate is 40 nm or more.

7. The separator according to claim 1, wherein the pre-compression air permeability of the porous polymer substrate is 75 s/100 cc or less.

8. The separator according to claim 1, wherein the post-compression air permeability of the porous polymer substrate is 120 s/100 cc or less.

9. The separator according to claim 1, wherein the resistance increase rate of the separator for the electrochemical device is 40% or less.

10. A manufacturing method of a separator for an electrochemical device, the method comprising:
stirring a polymer resin and a pore-forming agent to form a porous polymer substrate,
wherein the pore-forming agent is added two or more times.

11. The manufacturing method according to claim 10, wherein a stirring speed of the polymer resin and the pore-forming agent during a first addition of the pore-forming agent is larger than stirring speed during a second addition of the pore-forming agent.

12. The manufacturing method according to claim 10, wherein a stirring speed of the polymer resin and the pore-forming agent during a first addition of the pore-forming agent is 1.5 to 3 times the stirring speed during a second addition of the pore-forming agent.

13. The manufacturing method according to claim 10, wherein a stirring speed of the polymer resin and the pore-forming agent is 100 RPM to 300 RPM during a first addition of the pore-forming agent, and is 50 RPM to 150 RPM during a second addition of the pore-forming agent.

14. The manufacturing method according to claim 13, wherein a stirring speed of the polymer resin and the pore-forming agent is 20 RPM to 80 RPM during a third addition of the pore-forming agent.

15. An electrochemical device comprising:
a positive electrode;
a negative electrode; and
the separator according to claim 1, the separator being interposed between the positive electrode and the negative electrode.
